(19) United States
(12) Patent Application Publication
(10) Pub. No.: US 2026/0287395 A1
(43) Pub. Date: Sep. 24, 2026

(54) Measured Value Acquisition Device for an Inductive Sensor Arrangement

(71) Applicant: Robert Bosch GmbH, Stuttgart (DE)

(72) Inventors: Stefan Kuntz, Flein (DE); Miguel Nogueira, Braga (PT)

(21) Appl. No.: 19/568,162

(22) Filed: Mar. 16, 2026

(30) Foreign Application Priority Data
Mar. 18, 2025 (DE) 10 2025 110 296.1

(51) Int. Cl. G01D 5/20

(52) U.S. Cl. CPC G01D 5/20

(57) ABSTRACT

A measured value acquisition device for an inductive sensor arrangement including a circuit carrier including (i) an exciter structure, and (ii) at least two receiver structures. The at least two receiver structures are arranged adjacent to one another and have different lengths. Each receiver structure of the at least two receiver structures includes at least two receiver coils with at least one winding. The exciter structure includes an exciter coil with at least one winding. The at least one winding of the exciter coil encloses the at least two receiver coils of the at least two receiver structures. A contour path of the exciter coil defines an offset based on the different lengths of the at least two receiver coils of the at least two receiver structures.

This application claims priority under 35 U.S.C. § 119 to patent application no. DE 10 2025 110 296.1, filed on Mar. 18, 2025 in Germany, the disclosure of which is incorporated herein by reference in its entirety.

The disclosure relates to a measured value acquisition device for an inductive sensor arrangement. The object of the disclosure is also an inductive sensor arrangement having at least one such measured value acquisition device.

### BACKGROUND

Inductive sensor arrangements are known from the prior art, which have a measured value acquisition device with at least one exciter structure and at least one receiver structure and at least one coupling device, which is also referred to as a target. The at least one exciter structure further comprises at least one exciter coil. The at least one coupling device comprises at least one electrically conductive coupling element. The at least one receiver structure comprises at least one, but usually two, receiver coils. A high frequency current passes through the at least one exciter coil generating an alternating magnetic field, which induces eddy currents in the at least one coupling device. In this context, the inductive coupling of the at least one exciter coil and the at least one receiver coil depends on the position of the corresponding coupling device. The induced voltage signal in the at least one receiver coil can be used to infer the current position of the coupling device and thus the current position of a body whose movement is to be detected.

DE 100 26 019 B4 discloses an inductive position sensor, which comprises an oscillator circuit that generates a periodic AC voltage signal and couples it to an exciter coil, a plurality of receiver coils, an evaluation circuit, and a movable inductive coupling element, which influences the strength of the inductive coupling between the exciter coil and the receiver coils. The exciter coil and the receiver coils are configured as conductor tracks on a carrier plate. Each receiver coil has two taps, via which a voltage induced by the exciter coil in the associated receiver coil can be tapped. The evaluation circuit is arranged within the geometry of the transmitter and/or receiver coils and is designed to evaluate the signals induced in the receiver coils. The effective surfaces of the receiver coils in the initial and/or the end region of the sensor are configured such that the voltages induced by the exciter coil in each of the receiver coils, which can be tapped at the associated taps of the receiver coils, are zero when the movable element is not present. It can be considered disadvantageous in that the measurement range decreases with less than three receiver coils.

### SUMMARY

The measured value acquisition device for an inductive sensor arrangement with the features of independent claim 1 and the corresponding inductive sensor arrangement with the features of independent claim 11 each have the advantage that an offset voltage occurring in the at least two receiver coils of the at least two receiver structures can be reduced by a special form of the at least one exciter coil of the exciter structure and its arrangement relative to the receiver coils of the at least two receiver structures.

In embodiments of the disclosure, since the induced offset voltages related to the induced and demodulated measurement signals in the receiver coils of the at least two receiver structures, which result in the absence of the at least one coupling device, are compensated by an evaluation and control unit to keep the angle error or position error of the inductive sensor arrangement as small as possible, the reduction of the occurring offset voltages has a positive effect on the design of the evaluation and control unit. Without compensation for the occurring offset voltages, the angle error or position error of the inductive sensor arrangement would become impermissibly high, and the inductive sensor arrangement would not be useful. The ASICs (ASIC: application-specific integrated circuit) available on the market for designing the evaluation and control unit are limited in terms of the maximum offset voltage that can be compensated. In many coil designs, particularly in tight spaces where the at least one exciter coil cannot be arranged further away from the at least two receiver coils of the at least two receiver structures, this limit may often be reached if no further measures are taken.

In embodiments of the disclosure, the reduction of the offset voltages may result in an increase in signal quality and a reduction of the angle error. Often, the offset voltages may be compensated in the evaluation and control unit used to demodulate the measurement signals, and thus cause little angle error, but drifts of the offset compensation in the evaluation and control unit may cause significant angle error over the useful life and varying temperatures. In embodiments of the measured value acquisition device, the offset voltages of the coil system can be significantly minimized, particularly in “symmetrical” coil systems, and in comparison to other methods of offset minimization, also save design space with respect to the dimensions of the at least one exciter coil of the exciter structure. A reduction of the design space leads to cost savings, and often indirectly also to the reduction of the offset voltages, if the distance to other metal surfaces in the surrounding area can be reduced, for example.

Embodiments of the disclosure provide a measured value acquisition device for an inductive sensor arrangement having a circuit carrier comprising an exciter structure and at least two receiver structures. The at least two receiver structures are arranged adjacent to one another and have different lengths. The at least two receiver structures each comprise at least two receiver coils with at least one winding. The exciter structure comprises an exciter coil with at least one winding enclosing the receiver coils of the at least two receiver structures. In this case, a contour path of the exciter coil is adapted by an offset to the different lengths of the receiver coils of the at least two receiver structures such that offset voltages occurring at the at least two receiver coils of the at least two receiver structures, which are induced by the exciter coil, are each in a ratio to the amplitude of a corresponding received measurement signal, which is in a range from 0 to 0.5.

In addition, an inductive sensor arrangement for detecting a movement of a movable body, with at least two coupling devices, which each comprise at least one electrically conductive element, and such a measured value acquisition device, is proposed. The movable body whose movement is to be detected is coupled to the at least two coupling devices or the measured value acquisition device. An exciter structure and at least two receiver structures are arranged on a circuit carrier of the measured value acquisition device. The exciter structure is coupled to an evaluation and control unit, which couples a periodic alternating signal into the exciter structure during operation. The at least two coupling devices are each associated with one of the at least two receiver structures and designed to influence an inductive coupling between the exciter structure and the associated receiver structure of the measured value acquisition device. The at least one evaluation and control unit is designed to receive and evaluate signals induced in the at least two receiving structures and to determine a current position of the at least two movable coupling devices relative to the at least two receiving structures and/or a current position of the movable body.

Embodiments of the measured value acquisition device according to the disclosure for an inductive sensor arrangement provide the possibility to reduce the offset voltage without increasing the design space or expensive adjustments to the evaluation and control unit. With the least two receiver structures arranged adjacent to one another, the cause of the offset voltages lies primarily in an unequal ratio of right-sided and left-sided windings of the receiver coils. Ideally, in the absence of the at least two coupling devices, the measurement signal induced into the receiver coils is zero. However, because the field is not one hundred percent homogeneous and the receiver coils may have an asymmetric ratio between the right and left winding areas, there is a residual value which may be referred to as an offset. This is also affected by metallic parts in the area surrounding the system. Since the distance between the at least one exciter coil and the at least two receiver coils changes the homogeneity of the field in the at least two receiver structures, this distance can be optimized to optimize the offset and the offset voltages. Taking into account the distance in the direction of movement, this distance can be optimized to reduce the offset voltages induced into the receiver coils.

Embodiments of the inductive sensor arrangement may also be used to implement a nonius principle to implement a very long path and/or high resolution and accuracy of the measured value acquisition device.

The inductive sensor arrangement can, for example, be designed as a linear displacement sensor, in which the movable body performs a translational movement to be detected along an axis of movement, or as a rotary angle sensor or rotor position sensor, in which the movable body performs a rotary movement to be detected around a rotation axis. In the case of an inductive rotation sensor, the measured value acquisition device can preferably have a space-saving “C” shape, which can be attached to a shaft. This can simplify the manufacturing concept for integrating the inductive sensor arrangement. A coil layout for such a measured value acquisition device can be determined by a suitable choice of origin (0, 0) by a coordinate transformation of polar coordinates of a coil layout of a measured value acquisition device for an inductive linear position sensor into Cartesian coordinates.

In the present case, an evaluation and control unit can be understood as an electrical assembly or electrical circuit that prepares, processes or evaluates recorded sensor signals. Preferably, the evaluation and control unit can be designed as an ASIC component (ASIC: application-specific integrated circuit). The evaluation and control unit may comprise at least one interface, which may be implemented as hardware and/or software. When implemented as hardware, the interfaces may be part of the ASIC assembly, for example. However, it is also possible that the interfaces are dedicated integrated circuits or consist at least partly of discrete components. When implemented as software, the interfaces may be software modules present, for example, on a microcontroller alongside other software modules.

Advantageous improvements to the measured value acquisition device for an inductive sensor arrangement specified in independent claim 1 and the inductive sensor arrangement specified in independent claim 11 are possible by means of the measures and further embodiments specified in the dependent claims.

It is particularly advantageous that the ratio of the offset voltages occurring at the at least two receiver coils of the at least two receiver structures to the amplitude of the corresponding received measurement signal can each be in a range from 0 to 0.25. As a result, the advantages of embodiments of the disclosure may be further improved.

In an advantageous embodiment of the measured value acquisition device, contour paths of the at least one winding of the at least two receiver coils of the at least two receiver structures can be each arranged in such a way that the largest offset voltage of the offset voltages occurring at the at least two receiver coils of the at least two receiver structures induced by the exciter structure has a value that is less than a possible maximum value limited by the design, which occurs if a length of the exciter coil in the area of the first receiver structure is equal to a length of the exciter coil in the area of the second receiver structure.

In a further advantageous embodiment of the measured value detection device, the maximum values of the absolute values of the offset voltages occurring at the at least two receiver coils of the at least two receiver structures can be equal.

In a further advantageous embodiment of the measured value acquisition device, the contour paths of the at least one winding of the at least two receiver coils at the end regions of the at least two receiver structures can each be geometrically congruent. In this case, the congruence of the contour paths only relates to the pure path on the level without consideration of layer changes and vias in the circuit carrier.

In a further advantageous embodiment of the measured value detection device, distances of the contour path of the exciter coil to the at least two receiver structures at the end regions of the at least two receiver structures can be equal.

In a further advantageous embodiment of the measured value acquisition device, the contour path of the exciter coil at the end regions of the at least two receiver structures can be parallel to a contour path of at least one of the two receiver coils of the respective receiver structure.

In a further advantageous embodiment of the measured value acquisition device, a single winding of the at least two receiver coils can each comprise two loop structures, which form the contour path of the at least one winding of the corresponding receiver coil. The two loop structures of the individual windings of the at least two receiver coils can each comprise a plurality of loop sections and be formed on at least two levels of the circuit carrier. Sections of the individual loop structures arranged on different levels of the circuit carrier can be electrically connected to one another by means of vias. In addition, the two loop structures of the individual windings of the at least two receiver coils may have a phase shift of 180° and opposite flow directions with respect to one another.

In a further advantageous embodiment of the inductive sensor arrangement, the at least two coupling devices can be movable independently.

In a further advantageous embodiment of the inductive sensor arrangement, the at least two coupling devices may comprise a different number of electrically conductive coupling elements. This allows the nonius principle to be easily implemented.

Exemplary embodiments of the disclosure are shown in the drawings and explained in more detail in the following description. In the drawings, identical reference numerals refer to components or elements performing identical or similar functions.

### BRIEF DESCRIPTION OF THE DRAWINGS

FIG. 1 shows a schematic top view of a first exemplary embodiment of an inductive sensor arrangement according to the disclosure with a first exemplary embodiment of a measured value acquisition device according to the disclosure, wherein a circuit carrier of the measured value acquisition device is shown transparently.

FIG. 2 shows a schematic top view of the measured value acquisition device according to the disclosure from FIG. 1.

FIG. 3 shows a schematic top view of a second exemplary embodiment of a measured value acquisition device according to the disclosure for an inductive sensor arrangement.

FIG. 4 shows a schematic top view of a third exemplary embodiment of a measured value acquisition device according to the disclosure for an inductive sensor arrangement.

### DETAILED DESCRIPTION

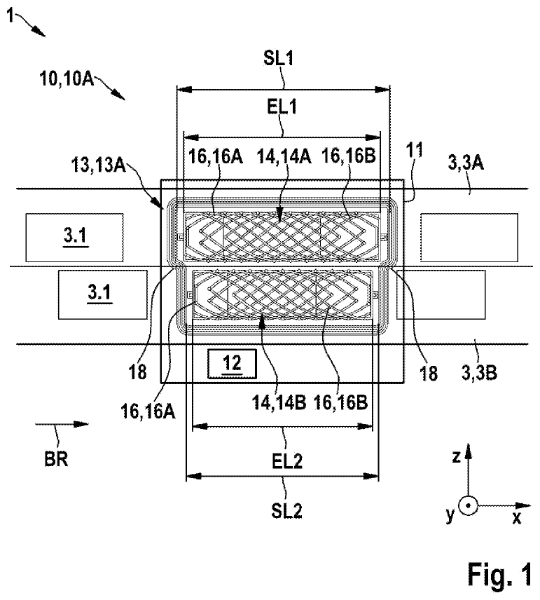

As FIGS. 1 to 4 show, the exemplary embodiments shown of a measured value acquisition device 10 for an inductive sensor arrangement 1 according to the disclosure each comprise a circuit carrier 11 which comprises an exciter structure 13 and at least two receiver structures 14. The at least two receiver structures 14 are arranged adjacent to one another and have different lengths EL1, EL2. The at least two receiver structures 14 each comprise at least two receiver coils 16 with at least one winding. The exciter structure 13 comprises an exciter coil 13A with at least one winding enclosing the receiver coils 16 of the at least two receiver structures 14. In this case, a contour path of the exciter coil 13A is adapted by an offset 18 to the different lengths EL1, EL2 of the receiver coils 16 of the at least two receiver structures 14 such that offset voltages occurring at the at least two receiver coils 16 of the at least two receiver structures 14, which are induced by the exciter coil 13A, are each in a ratio to the amplitude of a corresponding received measurement signal, which is in a range from 0 to 0.5.

As can further be seen from FIGS. 1 to 4, the exciter structure 13 in the illustrated exemplary embodiments of the measured value acquisition device 1 each comprises an exciter coil 13A with a plurality of windings. In addition, the illustrated exemplary embodiments of the measured value acquisition device 1 each comprise two receiver structures 14, which are arranged adjacent to one another at a predetermined distance A1 and each have two receiver coils 16 with a winding. A first receiver coil 16A of the individual receiver structures 14 forms a sine channel and a second receiver coil 16B of the individual receiver structures forms a cosine channel. As can further be seen from FIGS. 1 to 4, an individual winding of the two receiver coils 16 of the two receiver structures 14 each comprises two loop structures, which form the contour path of the winding of the corresponding receiver coil 16. The two loop structures of the individual windings of the two receiver coils 16 of the two receiver structures 14 each comprise a plurality of loop sections and are formed on at least two levels of the circuit carrier 11. Sections of the individual loop structures arranged on different levels of the circuit carrier 11 are electrically connected to one another by means of vias (DK). The two loop structures of the individual windings of the two receiver coils 16 of the two receiver structures 14 have a phase shift of 180° and opposite flow directions with respect to one another. The loop sections of the two loop structures are repeated periodically in each of the exemplary embodiments shown. This means that the two loop structures of the individual windings of the two receiver coils 16 of the two receiver structures 14 correspond to a mathematical oscillation with at least one period. In the illustrated exemplary embodiments, the mathematical oscillation or the repeating loop sections each comprise a sinusoidal shape or a cosinusoidal shape. In alternative non-illustrated exemplary embodiments, the mathematical oscillation or loop repeating sections have a rectangular shape or a triangular shape or a trapezoidal shape or a mixed shape. In addition, the sections of the individual loop structures arranged on different levels of the circuit carrier 11 correspond to a half period of the repeating loop sections.

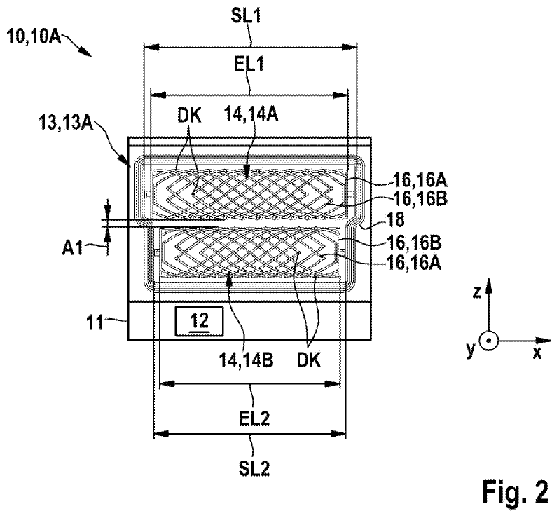

As can also be seen from FIGS. 1 and 2, the exemplary embodiment shown of the inductive sensor arrangement 1 according to the disclosure, designed as a linear displacement sensor, for detecting a movement of a movable body has at least two coupling devices 3, which each comprise at least one electrically conductive coupling element 3.1, and a measured value acquisition device 10 according to the disclosure. The movable body whose movement is to be detected is coupled to the at least two coupling devices 3 or the measured value acquisition device 10. An exciter structure 13 and at least two receiver structures 14 are arranged on a circuit carrier 11 of the measured value acquisition device 10. The exciter structure 13 is coupled to at least one evaluation and control unit 12, which couples a periodic alternating signal into the exciter structure 13 during operation. The at least two coupling devices 3 are each associated with one of the at least two receiver structures 14 and designed to influence an inductive coupling between the exciter structure 13 and the associated receiver structure 14 of the measured value acquisition device 10. The at least one evaluation and control unit 12 is designed to receive and evaluate signals induced in the at least two receiving structures 14 and to determine a current position of the at least two movable coupling devices 3 relative to the at least two receiving structures 14 and/or a current position of the movable body.

The at least one evaluation and control unit 12 is designed to receive, demodulate and evaluate signals induced in the at least two receiving structures 14 and to determine a current position of the movable coupling device 3 relative to the at least one receiving structure 14 and/or a current position of the movable body. For the sake of clarity, an electrical connection of the exciter coil 13A and the receiver coils 16 of the at least two receiver structures 14 to the evaluation and control unit 12 is not shown. Of course, the exciter coil 13A and the receiver coils 16 can be cut at a suitable location, for example at a via (DK), and guided to the evaluation and control unit 12 by means of additional conductor paths.

In the illustrated exemplary embodiment of the inductive sensor arrangement 1, the movable body not shown in greater detail performs a linear movement in the direction of arrow BR. In addition, two coupling devices 3, which have a different number of electrically conductive coupling elements 3.1 designed as surface elements, are coupled to the movable body.

In an alternative exemplary embodiment of the inductive sensor arrangement 1 not shown, the at least two coupling devices 3 are movable independently of one another.

In the illustrated exemplary embodiments of the measured value detection device 10, a contour path of the exciter coil 13A is adjusted by the offset 18 to the different lengths EL1, EL2 of the two receiver coils 16 of the two receiver structures 14 such that the ratio of the offset voltages occurring at the two receiver coils 16 of the two receiver structures 14 to the amplitude of the corresponding received measurement signal is each in a range from 0 to 0.25. In addition, the contour paths of the at least one winding of the two receiver coils 16 of the two receiver structures 14 are each designed such that the largest offset voltage of the offset voltages occurring at the two receiver coils 16 of the two receiver structures 14 induced by the exciter structure 13 has a value, which is less than a possible maximum value due to design constraints, which occurs when a first length SL1 of the exciter coil 13A in the area of the first receiver structure 14A is equal to a second length SL2 of the exciter coil 13A in the area of the second receiver structure 14B. Preferably, the maximum values of the absolute values of the offset voltages occurring at the two receiver coils 16 of the two receiver structures 14 are equal.

As can be seen further from FIGS. 1 and 2, the contour paths of the at least one winding of the two receiver coils 16 at the end regions of the two receiver structures 14 are each geometrically congruent. Also, a first receiver structure 14A is arranged with the distance A1, in the illustrations, above a second receiver structure 14B.

As can be further seen from FIGS. 1 and 2, the contour path of the exciter coil 13A at the end region of the first receiver structure 14A in the illustrated first embodiment of the measured value acquisition device 10A is parallel to a contour path of the two receiver coils 16 of the first receiver structure 14A. Analogously, the contour path of the exciter coil 13A after the offset 18 at the end region of the second receiving structure 14B is parallel to a contour path of the two receiver coils 16 of the second receiver structure 14B. As can be further seen from FIGS. 1 and 2, the distances of the contour path of the exciter coil 13A to the two receiver structures 14 at the end regions of the two receiver structures 14 are equal. The first exemplary embodiment of the measured value acquisition device 10A is used to detect linear movement in the inductive sensor arrangement 1 configured as a linear displacement sensor shown in FIG. 1.

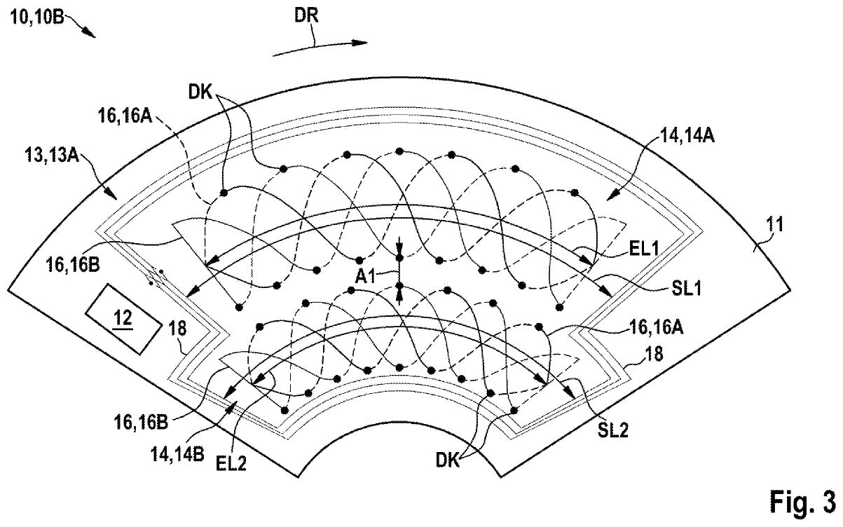

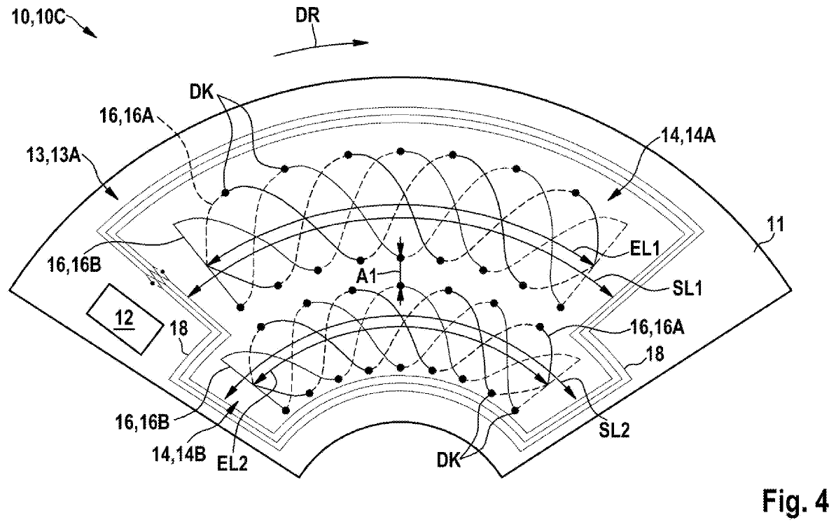

The second exemplary embodiment of the measured value acquisition device 10B shown in FIG. 3 and the third exemplary embodiment of the measured value acquisition device 10C shown in FIG. 4 each have a space-saving “C” shape, which can be inserted onto a shaft. The second exemplary embodiment of the measured value acquisition device 10B and the third exemplary embodiment of the measured value acquisition device 10C are used in an inductive sensor arrangement not shown in further detail designed as a rotary angle sensor or rotor position sensor, in which the movable body is designed to detect rotational movement in a direction of rotation DR about an axis of rotation. Also, a first receiver structure 14A is arranged with the distance A1, in the illustrations, above a second receiver structure 14B. The “C” shape can simplify the manufacturing concept for integrating the inductive sensor arrangement. A coil layout for such a measured value acquisition device can be determined by a suitable choice of origin (0, 0) by a coordinate transformation of polar coordinates of a coil layout of a measured value acquisition device for an inductive linear position sensor into Cartesian coordinates. For ease of illustration and clarity, FIG. 3 and FIG. 4 depict a contour path that is not geometrically congruent in the end regions of the two receiver structures 14A, 14B. Of course, even with a space-saving “C” shape, a geometrically congruent contour path is possible in the end regions of the receiver structures 14A, 14B.

As can further be seen from FIG. 3, the contour path of the exciter coils 13A at the end region of the first receiver structure 14A in the illustrated second exemplary embodiment of the measured value acquisition device 10B is at a decreasing distance from the contour path of the second receiver coil 16B of the first receiver structure 14A. Similarly, the contour path of the exciter coil 13A after offset 18 at the end region of the second receiver structure 14B is at a decreasing distance from a contour path of the second receiver coil 16B of the second receiver structure 14B. As can be further seen from FIG. 3, the slopes of the contour path of the exciter coil 13A differ at the end regions of the two receiver structures 14.

As can be further seen from FIG. 4, the contour path of the exciter coils 13A at the end region of the first receiver structure 14A in the illustrated third exemplary embodiment of the measurement detection device 10C is parallel to a contour path of a second receiver coil 16B of the first receiver structure 14A. Analogously, the contour path of the exciter coil 13A after offset 18 at the end region of the second receiver structure 14B is parallel to a contour path of the second receiver coils 16B of the second receiver structure 14B. As can be further seen from FIG. 4, the distances of the contour path of the exciter coil 13A to the two receiver structures 14 at the end regions of the two receiver structures 14 are approximately equal.

What is claimed is:

1. A measured value acquisition device for an inductive sensor arrangement, comprising:
a circuit carrier including (i) an exciter structure, and (ii) at least two receiver structures,
wherein the at least two receiver structures are arranged adjacent to one another and have different lengths,
wherein each receiver structure of the at least two receiver structures includes at least two receiver coils with at least one winding,
wherein the exciter structure includes an exciter coil with at least one winding,
wherein the at least one winding of the exciter coil encloses the at least two receiver coils of the at least two receiver structures,
wherein a contour path of the exciter coil defines an offset based on the different lengths of the at least two receiver coils of the at least two receiver structures,
wherein the contour path is configured so that the offset causes offset voltages occurring at the at least two receiver coils of the at least two receiver structures as induced by the exciter coil are each in a ratio to an amplitude of a corresponding received measurement signal, and
wherein the ratio is from 0 to 0.5.

2. The measured value acquisition device according to claim 1, wherein the ratio is from 0 to 0.25.

3. The measured value acquisition device according to claim 1, wherein contour paths of the at least one winding of the at least two receiver coils of the at least two receiver structures are each arranged such that a largest offset voltage of the offset voltages occurring at the at least two receiver coils of the at least two receiver structures induced by the exciter structure has a value that is less than a possible maximum value due to design constraints, which occurs when a length of the exciter coil in an area of a first receiver structure of the at least two receiver structures is equal to a different length of the exciter coil in an area of a second receiver structure of the at least two receiver structures.

4. The measured value acquisition device according to claim 3, wherein maximum values of absolute values of the offset voltages occurring at the at least two receiver coils of the at least two receiver structures are equal.

5. The measured value acquisition device according to claim 3, wherein the contour paths of the at least one winding of the at least two receiver coils are each geometrically congruent at end regions of the at least two receiver structures.

6. The measured value acquisition device according to claim 5, wherein distances of the contour path of the exciter coil to the at least two receiver structures are equal at the end regions of the at least two receiver structures.

7. The measured value acquisition device according to claim 5, wherein the contour path of the exciter coil at the end regions of the at least two receiver structures is parallel to one of the contour paths of at least one of the at least two receiver coils of a respective receiver structure of the at least two receiver structures.

8. The measured value acquisition device according to claim 1, wherein each individual winding of the at least two receiver coils of the at least two receiver structures includes two loop structures that form the contour path of the at least one winding of a corresponding receiver coil of the at least two receiver coils.

9. The measured value acquisition device according to claim 8, wherein:
the two loop structures of individual windings of the at least two receiver coils of the at least two receiver structures each comprise a plurality of loop sections and are formed in at least two levels of the circuit carrier, and
vias electrically connect sections of each loop structure of the two loop structures arranged on different levels of the circuit carrier.

10. The measured value acquisition device according to claim 9, wherein the two loop structures of individual windings of the at least two receiver coils of the at least two receiver structures have a phase shift of 180° and opposite flow directions with respect to one another.

11. An inductive sensor arrangement for detecting a movement of a movable body, comprising:
at least two coupling devices, each coupling device including at least one electrically conductive coupling element and the measured value acquisition device according to claim 1,
wherein the movable body is coupled to the at least two coupling devices or the measured value acquisition device,
wherein the exciter structure and the at least two receiver structures are arranged on the circuit carrier of the measured value acquisition device,
wherein the exciter structure is coupled to at least one evaluation and control unit configured to couple a periodic alternating signal into the exciter structure,
wherein the at least two coupling devices are each associated with one of the at least two receiver structures and are configured to influence an inductive coupling between the exciter structure and at an associated receiver structure of the measured value acquisition device, and
wherein the at least one evaluation and control unit is configured to receive and evaluate signals induced in the at least two receiver structures and to determine a current position of the at least two coupling devices relative to a corresponding receiver structure of the at least two receiver structures and/or a current position of the movable body.

12. The inductive sensor arrangement according to claim 11, wherein the at least two coupling devices are independently movable.

13. The inductive sensor arrangement according to claim 11, wherein the at least two coupling devices comprise a different number of electrically conductive coupling elements.

14. The inductive sensor arrangement according to claim 11, wherein:
the movable body performs a rotational movement about a rotational axis, or
the movable body performs a linear movement.
